(19) United States
(12) Patent Application Publication
(10) Pub. No.: US 2009/0089739 A1
(43) Pub. Date: Apr. 2, 2009

(54) INTELLIGENT EDITING OF RELATIONAL MODELS

(75) Inventors: Laurent Mollicone, Kirkland, WA (US); James R. Flynn, Redmond, WA (US); William A. Manis, Sammamish, WA (US); Stephen Michael Danton, Seattle, WA (US); Florian Voss, Seattle, WA (US); Kean EE Lim, Issaquah, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/864,397

(22) Filed: Sep. 28, 2007

(51) Int. Cl. G06F 9/44

(52) U.S. Cl. 717/105

(57) ABSTRACT

In one embodiment, receives a user gesture indicating an edit to be performed on a target object within a model. The model is based on an underlying schema including constraints that define relationships between objects in the model, including the target object. The computer system determines that at least one of the constraints in the underlying schema is associated with the indicated edit of the target object and determines that the edit is valid. The valid edit complies with the constraints associated with the indicated edit of the target object. In another embodiment, a computer system receives a user gesture indicating an edit, determines that a constraint in the underlying schema is associated with the indicated edit, and provides an indication of a valid model edit to a computer user.

### BACKGROUND

Computers have become highly integrated in the workforce, in the home, and in mobile devices. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In some cases, software applications can be used to generate and manipulate models. For example, businesses and other entities may use models to describe processes and systems. Models may also represent different types of information in various forms. In some cases, a model may represent data in the form of a flow diagram. In other cases, a model may represent data in the form of process flows, flowcharts, process diagrams and/or control charts. In other cases, models are used to illustrate organizational relationships between resources in a system. These models are often referred to as organizational charts. In a broader sense, models may be used to show any type of relationship information between different objects.

Typically, models have associated schemas that describe the terminology used in the model. The schema acts as a sort of legend, allowing a user or software application to consult the schema to determine the intended meaning of a term or symbol used in the model. Some schemas can include user-definable tags (e.g. extensible markup language (XML) tags), as well as metadata that corresponds to various elements in the model. The metadata can be used to describe properties of an object such as the object's look and feel, its layout and even its content. Thus, computer-run software applications can be used to generate and manipulate models.

### BRIEF SUMMARY

Embodiments described herein are directed to verifying the validity of an edit to be performed on a target object within a model and suggesting one or more valid edits. In one embodiment, a computer system performs a method for verifying the validity of an edit to be performed on at least one target object within a model. The computer system receives a user gesture indicating an edit to be performed on a target object within a model. The model is based on an underlying schema including constraints that define relationships between objects in the model, including the target object. The computer system determines that at least one of the constraints in the underlying schema is associated with the indicated edit of the target object. Based on the determination, the computer system determines that the edit is valid. The valid edit complies with the constraints associated with the indicated edit of the target object.

In another embodiment, a computer system suggests valid model edits based on an indicated user gesture corresponding to a model object. The computer system receives a user gesture indicating an edit to be performed on a target object within a model. The model is based on an underlying schema comprising one or more constraints that define relationships between objects. The computer system determines that at least one of the constraints in the underlying schema is associated with the indicated edit of the target object. Lastly, the computer system provides an indication as of a valid model edit to a computer user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including verifying the validity of an edit to be performed on a model and suggesting valid model edits based on an indicated user gesture.

FIG. 2 illustrates a flowchart of an example method for verifying the validity of an edit to be performed on at least one target object within a model.

FIG. 3 illustrates a flowchart of an example method for suggests valid model edits based on an indicated user gesture corresponding to a model object.

FIGS. 4A-4D illustrate embodiment of the present invention in which connections between endpoints in models are edited based on user gestures.

### DETAILED DESCRIPTION

Embodiments described herein are directed to verifying the validity of an edit to be performed on a target object within a model and suggesting one or more valid edits. In one embodiment, a computer system performs a method for verifying the validity of an edit to be performed on at least one target object within a model. The computer system receives a user gesture indicating an edit to be performed on a target object within a model. The model is based on an underlying schema including constraints that define relationships between objects in the model, including the target object. The computer system determines that at least one of the constraints in the underlying schema is associated with the indicated edit of the target object. Based on the determination, the computer system determines that the edit is valid. The valid edit complies with the constraints associated with the indicated edit of the target object.

In another embodiment, a computer system suggests valid model edits based on an indicated user gesture corresponding to a model object. The computer system receives a user gesture indicating an edit to be performed on a target object within a model. The model is based on an underlying schema comprising one or more constraints that define relationships between objects. The computer system determines that at least one of the constraints in the underlying schema is associated with the indicated edit of the target object. Lastly, the computer system provides an indication of a valid model edit to a computer user.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry or transport desired program code means in the form of as computer-executable instructions or data structures and which can be accessed by a general purpose or special purpose computer. Combinations of the above should also be included within the scope of computer-readable media.

However, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

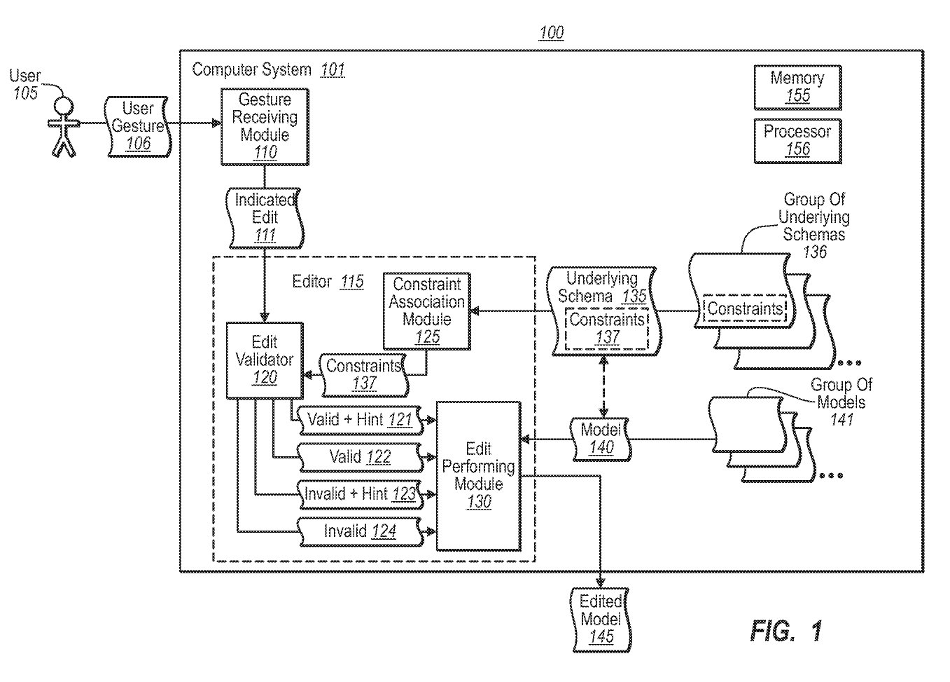

FIG. 1 illustrates a computer architecture 100 in which the principles of the present invention may be employed. Computer architecture 100 includes computer system 101. In some embodiments, computer system 101 may include system as memory 155 and a processor 156. As explained above, memory 155 may be any type of computer memory including RAM, ROM, solid state, magnetic or other memory. Similarly, processor 156 may be any type of processor, microcontroller, state machine or other means of processing information and/or controlling computer system functionality.

Computer system 101 may also include gesture receiving module 110. In some embodiments, gesture receiving module 110 may be configured to receive user gesture 106 from user 105. User 105 may be any type of computer user capable of interacting with a computer system. User gesture 106 may be any type of input capable of interpretation by a computer system. For example, user gestures may include mouse clicks, keyboard inputs, drag and drops, click and drags, mouseovers, touch inputs via a touch screen or any type of user or object movement as captured by a camera or video recorder. Gesture receiving module 110 may be configured to receive and interpret user gesture 106 as an intended command. For instance, if a user inputs a drag and drop gesture, gesture receiving module 110 may interpret that gesture as a command to select an item and move the item to the location where the item was “dropped.” Of course, many other gesture/command combinations are possible. Additionally or alternatively, user 106 may define how certain gestures are to be interpreted by gesture receiving module 110.

The product of an interpreted gesture is an indicated edit 111. For example, if a user inputs gesture 106, gesture receiving module 110 may interpret the gesture as a certain command. This command may designate an edit that is to be performed on an object (e.g. indicated edit 111). For example, in some cases, computer system 101 is configured to edit models. A model, as the term is used herein, can include any type of framework or structure that allows information to be as presented to a user. Such a framework can be used to organize information. For example, models may be used to illustrate organizational relationships between resources in a system. These are often referred to as organizational charts or org charts. Org charts often present information in a hierarchical, top to bottom structure. Models can also be used to show process flows. Such models are often referred to as flow diagrams, process flows, flowcharts, process diagrams or control charts. These models show the various routes a process can take on its way to completion. Other models capable of being displayed in various forms with some type of relationship information linking the various types of information may also be used.

In some cases, models use schemas to define relationships between different information represented by the model. For example, an org chart may begin with a “President” field and end with a “Part-time” field, where each field in between is linked to other fields. For example, “President” may be linked to “Vice President” which may be linked to “Level 1 Manager” which may be linked to the “Part-time” field. Each of the links may be defined as a relationship, and each relationship may be stored as a constraint within the schema for that model. The schema may go on to define what types of information may be included in each field. For example, a “President” tag may be used in the schema to designate information associated with the company president. The “President” tag may allow for different information than the “Part-time” tag allows for. Information such as name, address, bio, resume, board memberships, etc. may all be available for the president, whereas less information may be available for a part-time employee.

This example of using a schema and constraints to define information and relationships between information fields is merely one example of many types of possible uses for models, schemas and constraints. Many other variations are possible. This example is provided to illustrate the interrelationship between models, schemas and constraints.

As explained above, gesture receiving module 110 may receive user gesture 106, interpret the gesture as a command used to edit a model, and output the indicated edit 111. Indicated edit 111 may include any type of command capable of editing an item. For example, indicated edit 111 may include cutting, copying, pasting, coloring, re-shaping, line-drawing, moving, re-linking, re-connecting, deleting, adding, or any other command intended to alter an object, including a model. In some embodiments, model 140 is based on underlying schema 135 and corresponding constraints 137. In such cases, underlying schema 135 and/or constraints 137 may include limitations on which edits may be performed on model 140. Thus, edit validator 120 may be configured to validate indicated edit 111 by checking the indicated edit against the limitations of schema 135 and constraints 137.

For example, in some cases, user 105 may desire to edit model 140 based on schema 135 and constraints 137. In other cases, user 105 may desire to create a model based on a selected schema and corresponding constraints. In some cases, user 105 may select underlying schema 135 and corresponding constraints 137 from a group of underlying schemas 136, where each schema has corresponding constraints. In other cases, a user may select a model to edit from the group of models 141. In such cases, the selected model will have a corresponding schema and constraints from the group of underlying schemas 136. Thus, whether user 105 selects a model or merely a schema, constraint association module 125 may receive the model and/or schema and determine whether any of the corresponding constraints are associated with indicated edit 111.

Constraint association module 125 may be configured to determine whether a constraint is associated with an indicated edit in a variety of manners. For example, user 105 may drag an object onto another object with the intent that the objects will be connected with a line, designating that the objects have some type of relationship. Constraint association module 125 may identify the two objects and access the constraints to determine whether the constraints allow the two objects to be shown as connected and having some type of relationship. Constraint association and edit validity determination will be explained in greater detail below.

Edit validator 120 may be configured to communicate with edit performing module 130. In some embodiments, edit performing module 130 performs the indicated edit, once the edit has been declared to be valid by edit validator 120. It should be noted that an edit declared to be invalid may be retained and may even be presented to the user in a marked-up form identifying the edit as invalid. In still other cases, it may be desirable to provide a hint to user 105 as to which edits are allowable based on constraints 137. Thus, even where edit validator 120 has determined that the indicated edit is valid (e.g. valid determination 122), the validator 120 may also include one or more hints indicating other allowable edits. Thus, edit validator 120 may output determinations of valid with a hint (121), valid (122), invalid with a hint (123) and invalid (124). Thus, in cases where a hint is provided, user 105 may indicate to edit performing module 130 to perform the provided edit in addition to or alternative to the indicated edit. Thus, edit performing module 130 edits and/or creates the model based on one or more indicated and/or provided edits, resulting in edited model 145. In some cases, the combination of edit validator 120, constraint association module 125 and edit performing module 130 may be referred to as editor 115.

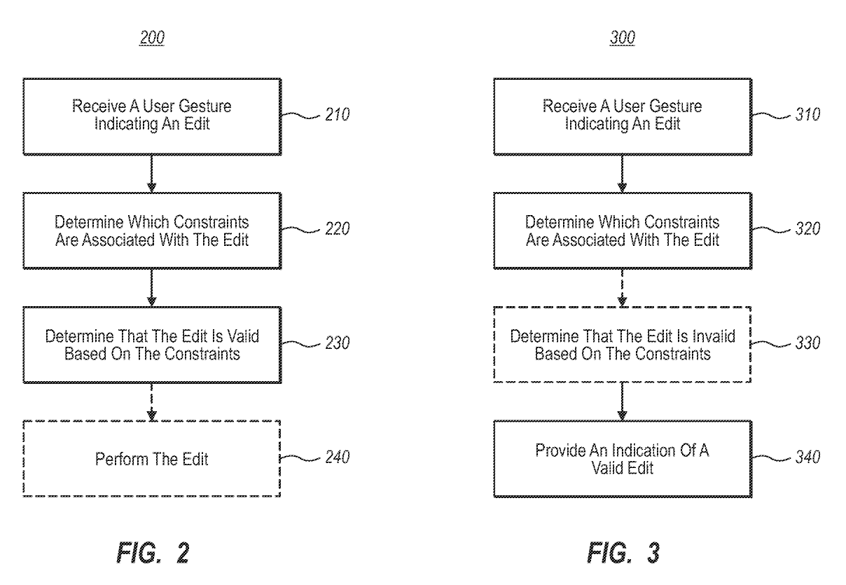

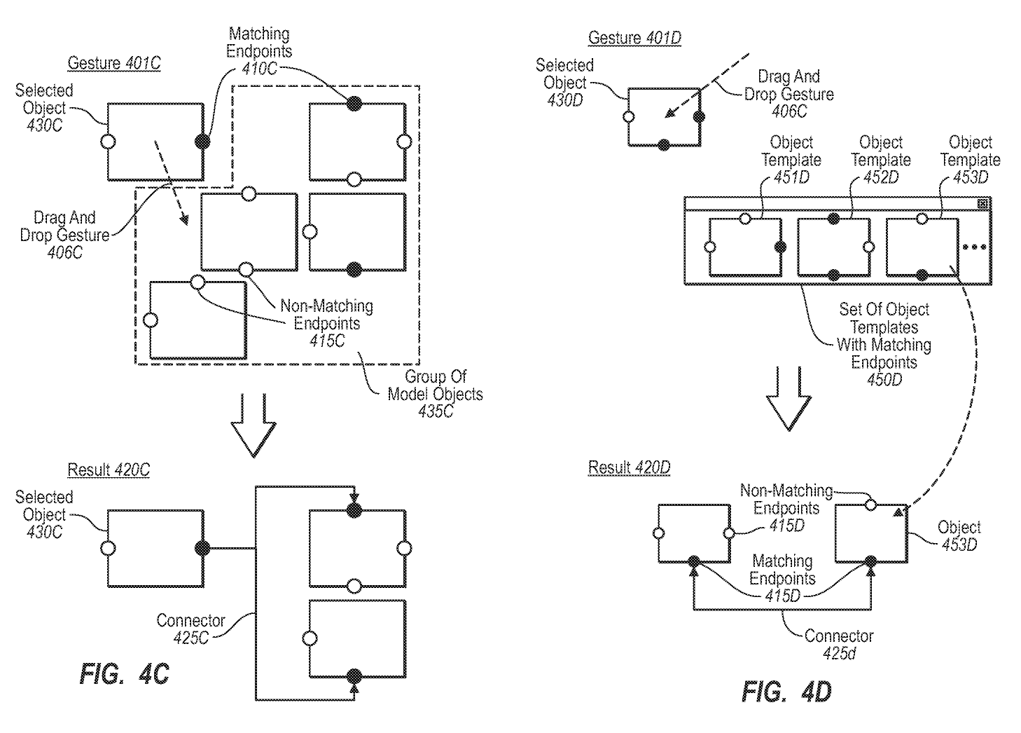

FIG. 2 illustrates a flowchart of a method 200 for verifying the validity of an edit to be performed on at least one target object within a model. FIGS. 4A-4D illustrate examples of model editing based on user gestures. The method 200 will now be described with frequent reference to the components and data of environment 100 and the model editing examples of FIGS. 4A-4D.

Method 200 includes an act of receiving a user gesture indicating an edit to be performed on at least one target object within a model, the model being based on an underlying schema comprising one or more constraints that define relationships between objects in the model including the target object (act 210). For example, gesture receiving module 110 may receive user gesture 106 indicating that indicated edit 111 is to be performed on at least one target object within model 140, model 140 being based on underlying schema 135 and corresponding constraints 137 that define relationships between objects in model 140 including the target object. As mentioned above, gesture receiving module 110 may receive any type of user gesture from user 105. In some cases, module 110 is configured to interpret gestures and identify an edit indicated by the gesture.

For example, gestures such as double clicking a target object or dragging and dropping the target object onto another object may indicate different edits. In some embodiments, double clicking a target object may automatically duplicate the target object, creating a new identical object. Dragging and dropping the target object onto another object, on the other hand, may indicate that the target object is to be connected to the other object with a line or other connector. As will be appreciated, these and other gestures may each be interpreted differently based on the default configuration of the gesture receiving module 110 or based on a user-customized configuration of module 110.

Method 200 also includes an act of determining that at least one of the constraints in the underlying schema is associated with the indicated edit of the target object (act 220). For example, constraint association module 125 may determine that at least one of constraints 137 corresponding to underlying schema 135 is associated with indicated edit 111 of the target object. In some embodiments, model object 431A of FIG. 4A may be the target object. For example, FIG. 4A depicts a gesture 401A where a user (e.g. user 105) has drawn a line 405A between a selected object 430A and object 431A, the target object in this case.

Each model object may have endpoints representing positions on the object where connectors may be placed. The connectors 425A-D connect objects to other objects. In some cases, the connections represent relationships between the objects, as defined by the underlying schema of the model and the corresponding constraints. Thus, as depicted in FIGS. 4A-4D, non-matching endpoints 415A-D represent portions of the object that cannot be connected to a selected object and matching endpoints 410A-D represent portions of the object that can be connected to a target object, the connection being permitted based on the constraints of the model.

Thus, as illustrated in FIG. 4A, a user may input a gesture drawing a line 405A between object 430A and 431A. The gesture is received by gesture receiving module 110, and it is determined the gesture indicates that the two objects are to be connected with a connector (e.g. connector 425A). Constraint association module 125 may determine that the indicated edit of connecting the two objects with a connector is permitted by constraints 137 at matching endpoints 410A. Thus, result 420A illustrates objects 430A and 431A as being connected by connector 425A at matching endpoints 410A.

Lastly, method 200 includes, based on the determination that at least one of the constraints in the underlying schema is associated with the indicated edit of the target object, an act of determining that the edit is valid, the valid edit complying with the at least one constraint associated with the indicated edit of the target object (act 230). For example, based on the determination by the constraint association module 125 that at least one of constraints 137 of underlying schema 135 is associated with indicated edit 111 for object 431A, edit validator 120 may determine that indicated edit 111 is valid because the edit complies with at least one of constraints 137 associated with indicated edit 111 for object 431A. Thus, in the above example, because constraints 137 indicate that a relationship exists between matching endpoints 410A, and because the user gesture was determined to be valid for the model (valid determination 122), the indicated edit of drawing a connector between the matching endpoints 410A may be performed by edit performing module 130 (optional act 240). The endpoints corresponding to at least one constraint of the underlying schema may be highlighted in a user display. In some embodiments, the model 140 may be displayed, edited and/or created in a visual modeling application.

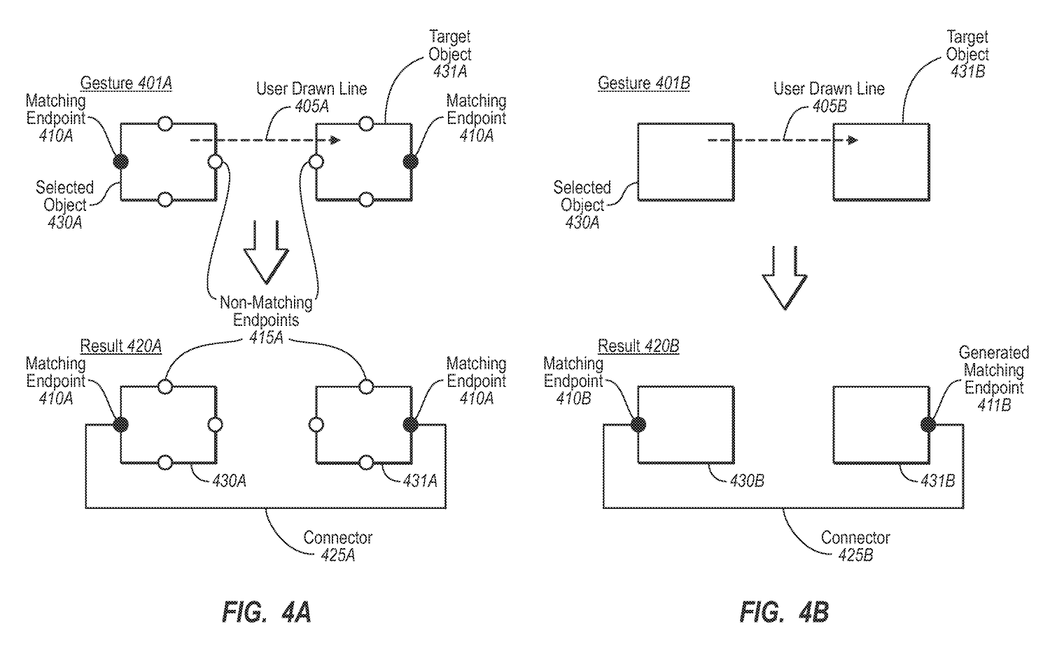

FIG. 3 illustrates a flowchart of a method 300 for suggesting one or more valid model edits based on an indicated user gesture corresponding to a model object. The method 300 will now be described with frequent reference to the components and data of environment 100 and the model editing examples of FIGS. 4A-4D.

Method 300 includes an act of receiving a user gesture indicating an edit to be performed on at least one target object within a model, the model being based on an underlying schema comprising one or more constraints that define relationships between objects (act 310). For example, gesture receiving module 110 may receive user gesture 106 and indicate that indicated edit 111 is to be performed on at least one target object (e.g. object 431B) within model 140, model 140 being based on underlying schema 135 including constraints 137 that define relationships between objects in the model.

Method 300 also includes an act of determining that at least one of the constraints in the underlying schema is associated with the indicated edit of the target object (act 320). For example, constraint association module 125 may determine that at least one of constraints 137 in underlying schema 135 is associated with indicated edit 111 for the target object (e.g. object 431B). Thus, constraints in the underlying domain model corresponding to the selected object and/or the target object are evaluated. Editor validator 120 makes determinations as to the validity of the indicated edit 111 based on the evaluation of the constraints—specifically, whether any of the model's constraints apply to indicated edit 111.

Method 300 may optionally include, based on the determination that at least one of the constraints in the underlying schema is associated with the indicated edit of the target object, an act of determining, based on the constraints associated with the indicated edit to be performed on the target object, that the model edit corresponding to the user gesture is invalid (optional act 330). For example, based on the determination that at least one of constraints 137 in underlying schema 135 is associated with indicated edit 111 for a target object (e.g. object 431B), edit validator 120 may determine, based on constraints 137 associated with indicated edit 111 to be performed on the target object, that the indicated edit 111 corresponding to user gesture 106 is invalid.

Indicated edit 111 may be declared invalid (invalid determination 124) for a variety of reasons. For example, a selected object (e.g. object 430B) may have no matching endpoints with a target object (e.g. object 431B), as illustrated in FIG. 4B. Furthermore, constraints 137 may indicate that selected object 430B and 431B do not or are not allowed to have a relationship between them. For example, the model may include a process flow chart with multiple steps, each of which must be completed in succession. A user may input a gesture indicating a selection of a first process box and an indication that the first box is to be connected to the third process box by a connector (e.g. the user dragged the first box onto the third box). In this case, constraint association module would determine that there are constraints associated with this edit and edit validator would return a determination of invalid based on the constraints. Note that this is only one example of an invalid edit, as determined by the constraints and underlying schema of the model, and that many other different and more complex examples are also possible.

Lastly, method 300 includes, based on the invalidity determination, an act of providing an indication of at least one valid model edit to a computer user (act 340). For example, based on the invalidity determination 124, edit validator 120 may provide an indication of at least one valid model edit (e.g. hints 121 and 123) to computer user 105. As shown in FIG. 4B, a user may input gesture 401B, a user-drawn line 405B between selected object 430B and target object 431B. In this case, no endpoints are present because potential relationships between the two objects have not been determined. After receiving the indicated edit 111 based on gesture 401B, edit validator may provide, based on constraints 125, an indication that the two objects may be connected and, further, which portions of the objects should be connected. Thus, in result 420B, matching endpoints 410B and 411B are connected by connector 425B, where endpoint 411B was generated based on the constraints pertaining to objects 410B and 411B.

In some cases, edit validator 120 may provide a hint, or indication of a valid model edit based on indicated edit 111, even when the edit is determined to be valid. Thus, edit validator 120 may send four different determinations to edit performing module 130: valid and a hint 121, valid 122, invalid and a hint 123 and invalid 124. In some cases, edit validator 120 may provide a plurality of valid model edits in response to indicated edit 111 and in accordance with the constraints of the underlying schema.

As illustrated in FIG. 4C, a model may have multiple objects with multiple endpoints. In some embodiments, under gesture 401C, a user may drag selected model object 430C into the outlined area of a group of model objects 435C and drop it somewhere in that area (drag and drop gesture 406C). Edit validator may make determinations based on the constraints for each object of each model (in cases where more than one model is present) as to possible endpoint matches. Thus, in result 420C, matching endpoints 410C are connected via connector 425C and non-matching endpoints 415C are not connected. In some cases, where more than one endpoint matches according to its corresponding constraints, the user may be prompted with an option box to determine whether to connect to one box, a selection of boxes, or all the matching boxes. Furthermore, in some embodiments, objects that have no matching endpoints with selected object 430C are discarded or otherwise removed from view, thus allowing the user to concentrate on those objects that are associated with selected object 430C.

In FIG. 4D, another scenario is illustrated under gesture 401D, in which a user selects selected object 430D and drags and drops it into open space within a visual model editing program. In some embodiments, user 105 has selected an endpoint that is to be matched (e.g. endpoint 412D) to other endpoints in one or more other objects (e.g. models). A set of object templates with matching endpoints 450D may be displayed to the user, allowing the user to select between object templates that have endpoints that correspond to endpoint 412 according to the constraints of each object's underlying schema. Thus, in this example, a user may select from object templates 451D, 452D and 453D, each of which has at least one matching endpoint. As illustrated in result 420D, user 105 may select object template 453D, the matching endpoints of which (e.g. matching endpoints 410D) are connected by connector 425D. Non-matching endpoints 415D of the objects are not connected. Similar to the scenario described above, a user may optionally select multiple objects that have matching endpoints. Furthermore, the user may perform gestures indicating other edits to be performed on the selected objects. These gestures are similarly processed and are performed if determined to be valid based on the constraints of the underlying schema(s).

In some cases, edit validator 120 provides a hint that includes a valid model edit that is functionally substantially similar to the invalid model edit. Thus, if a user attempts to modify an object or create a relationship between two objects and the gesture leads to an invalid edit, edit validator 120 may determine other edits that are similar to that indicated by the gesture.

In some embodiments, upon determining that the indicated edit I II is invalid, edit performing module 130 may prevent the model edit from being performed. Additionally or alternatively, edit performing module 130 may create a new model object corresponding to the constraints of the underlying schema. The user may select the type of new model object to be created. In some embodiments, displayed model edits provided as hints may be described in textual form. In others, the displayed valid model edits may include superimposed images indicating the proposed effect of the edit on the model. Thus, a user would be able to determine from the superimposed image whether or not to perform the edit.

Thus, a user may perform gestures that indicate edits to be carried out on one or more models. The validity of the edits may be determined before applying them to ensure that the user is editing the model(s) in a valid manner based on the constraints of the underlying schema(s) of the model(s). Furthermore, where a user has indicated an invalid edit, hints may be provided so that the user can indicate valid edits to be performed on the model.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system, a method for verifying the validity of an edit to be performed on at least one target object within a model, the method comprising:
an act of receiving a user gesture indicating an edit to be performed on at least one target object within a model, the model being based on an underlying schema comprising one or more constraints that define relationships between objects in the model including the target object;
an act of determining that at least one of the constraints in the underlying schema is associated with the indicated edit of the target object;
based on the determination, an act of determining that the edit is valid, the valid edit complying with the at least one constraint associated with the indicated edit of the target object.

2. The method of claim 1, further comprising an act of displaying the model in a visual modeling application.

3. The method of claim 1, further comprising an act of performing the indicated edit in response to a determination that the edit is valid.

4. At a computer system, a method for suggesting one or more valid model edits based on an indicated user gesture corresponding to a model object, the method comprising:
an act of receiving a user gesture indicating an edit to be performed on at least one target object within a model, the model being based on an underlying schema comprising one or more constraints that define relationships between objects;
an act of determining that at least one of the constraints in the underlying schema is associated with the indicated edit of the target object; and
an act of providing an indication of at least one valid model edit to the computer user.

5. The method of claim 4, further comprising:
based on the determination, an act of determining, based on the constraints associated with the indicated edit to be performed on the target object, that the model edit corresponding to the user gesture is invalid; and
wherein the act of providing an indication of at least one valid model edit to a computer user is based on the invalidity determination.

6. The method of claim 4, further comprising:
based on the determination, an act of determining, based on the constraints associated with the indicated edit to be performed on the target object, that the model edit corresponding to the user gesture is valid; and
wherein the act of providing an indication of at least one valid model edit to a computer user is based on the validity determination.

7. The method of claim 4, wherein the valid model edit is functionally substantially similar to the invalid model edit.

8. The method of claim 4, further comprising, based on the invalidity determination, an act of preventing the model edit from being performed.

9. The method of claim 4, further comprising, in response to the invalidity determination and based on the user gesture, an act of generating one or more valid edits complying with the constraints associated with the target object.

10. The method of claim 4, wherein model objects are connected to other model objects using connectors, the connectors connecting to endpoints in each object.

11. The method of claim 10, wherein each endpoint corresponds to at least one constraint of the underlying schema.

12. The method of claim 11, wherein the valid edit comprises establishing a connector between an endpoint of the target object and an endpoint of another object.

13. The method of claim 11, wherein endpoints corresponding to at least one constraint of the underlying schema are highlighted in a user display.

14. The method of claim 4, wherein a plurality of valid model edits are provided in response to the indicated user gesture and in accordance with the constraints of the underlying schema.

15. The method of claim 14, further comprising displaying a list of choices for the user to choose from, each choice in the list comprising at least one of the plurality of valid model edits.

16. The method of claim 4, further comprising, in response to the invalidity determination and in response to the indicated edit, an act of creating a new model object corresponding to the constraints of the underlying schema.

17. The method of claim 16, further comprising allowing the user to select the type of new model object to be created.

18. A computer program product comprising one or more computer-readable media having thereon computer-executable instructions that, when executed by one or more processors of a computing system, cause the computing system to perform a method for suggesting one or more valid model edits based on an indicated user gesture corresponding to a model object, the method comprising:
an act of receiving a user gesture indicating a selection of an object in a model, the model being based on an underlying schema comprising one or more constraints that define relationships between objects in the model;
an act of evaluating constraints in the underlying domain model corresponding to the selected object;
an act of determining, based on the selected object and the constraint evaluation, one or more valid model edits corresponding to the selected object; and
an act of displaying the one or more valid model edits to the user.

19. The computer program product of claim 18, wherein the displayed valid model edits are described in textual form.

20. The computer program product of claim 18, wherein the displayed valid model edits comprise superimposed images indicating the effect of the edit on the model.
